(19) United States
(12) Patent Application Publication
(10) Pub. No.: US 2023/0051079 A1
(43) Pub. Date: Feb. 16, 2023

(54) MOTION-COMPENSATING SENSING SYSTEM FOR COLLECTION OF ATMOSPHERIC RELEVANT PARAMETERS

(71) Applicant: Science and Technology Corporation, Hampton, VA (US)

(72) Inventor: Kimberly A. Bestul, Cottonwood Heights, UT (US)

(21) Appl. No.: 17/819,424

(22) Filed: Aug. 12, 2022

Related U.S. Application Data
(60) Provisional application No. 63/233,457, filed on Aug. 16, 2021.

(51) Int. Cl. G01P 5/24; G01P 13/02

(52) U.S. Cl. CPC G01P 5/245; G01P 13/025

(57) ABSTRACT

A system for collecting atmospheric data includes a frame and sensors to include a sonic anemometer for measuring wind data samples in each of three dimensions, and motion sensors for measuring angles of roll motion, pitch motion and yaw motion of the sonic anemometer. A tether is coupled to a cable payout/retriever, a lighter-than-air balloon, and the frame such that the payout/retriever and balloon control movement of the frame through a region of an atmosphere. A processor receives the wind data samples and the sensed angles, and maps the wind data samples to a fixed local horizontal reference plane of the sonic anemometer that is normal to a local gravitational vector at the region of the atmosphere to generate samples of compensated data. The processor averages samples of compensated data to generate averaged compensated data that is indicative of wind speed and wind direction in the region of the atmosphere.

Pursuant to 35 U.S.C. § 119, the benefit of priority from provisional application 63/233,457, with a filing date of Aug. 16, 2021, is claimed for this non-provisional application.

### STATEMENT OF GOVERNMENT INTEREST

This invention was made with Government support under contract 80AFRC19D0001 awarded by the National Aeronautics and Space Administration (NASA). The Government has certain rights in this invention.

### FIELD OF THE INVENTION

The invention relates generally to measurement of atmospheric relevant parameters, and more particularly to a motion-compensating sensing system that can collect (i.e., measure and capture) atmospheric relevant parameters as the sensing system transits the atmospheric boundary layer.

### BACKGROUND OF THE INVENTION

Atmospheric research of the Earth's (or any other planetary body's) boundary layer provides critical information for the field of climate modeling. Some of the key modeling parameters are atmospheric pressure, temperature, relative humidity, air quality such as particulate matter with diameters less than 2.5 μm, wind speed, and wind direction.

The thickness or altitude of Earth's atmospheric boundary layer varies diurnally reflecting the effect of solar radiation on atmospheric thermodynamic profiles in response to the solar heating and infrared cooling of the ground surface region immediately there under. Earth's atmospheric boundary layer can range from several hundred meters to several thousand meters above ground level. In order to measure and capture important information throughout an atmospheric boundary layer, measurement devices/systems must collect data within the boundary layer. Some existing measurement devices/systems move through a boundary layer via an ascending blimp or balloon tethered thereto. Unfortunately, the rudimentary nature of these existing devices/systems results in coarse sampling intervals, sensor flaws and inconsistent dependability. Furthermore, use of primitive sensor technology and data collection/processing schemes does not provide the accuracy and resolution needed for modern boundary layer reliant research endeavors.

### SUMMARY OF THE INVENTION

Accordingly, it is an object of the present invention to provide a sensing system for gathering atmospheric relevant parameters within the atmospheric boundary layer.

Another object of the present invention is to provide a tethered sensing system that can readily transit through an atmospheric boundary layer and communicate atmospheric relevant parameters as they are measured and captured.

Still another object of the present invention is to provide a tethered sensing system and method that eliminates the effect of the chaotic motion of the sensing system that is moved through an atmospheric boundary layer by means of concurrent motion compensation

Other objects and advantages of the present invention will become more obvious hereinafter in the specification and drawings.

In accordance with the present invention, a system for collecting atmospheric data includes a frame and sensors coupled thereto for sensing atmospheric relevant parameters. The sensors include a sonic anemometer for measuring wind data samples in each of three dimensions. The sensors further include motion sensors for measuring angles of roll motion, pitch motion and yaw motion of the sonic anemometer at each of the wind data samples. A tether has a first end coupled to a cable payout/retriever and has a second end coupled to a lighter-than-air balloon. The tether is coupled to the frame between its first end and second end. The payout/retriever and the balloon control movement of the frame through a region of an atmosphere. A processor is provided for receiving the wind data samples and the sensed angles. The processor maps the wind data samples to a fixed local horizontal reference plane of the sonic anemometer that is normal to a local gravitational vector at the region of the atmosphere using the sensed angles. As a result, samples of compensated data are generated. The processor averages a plurality of the samples of compensated data to generate averaged compensated data that is indicative of wind speed and wind direction in the region of the atmosphere.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of a motion-compensating sensing system for the collection of atmospheric relevant parameters in accordance with the present invention;

FIG. 2 is a schematic view of the sensing system's airborne assets to include a sonic anemometer with its x,y,z reference frame overlaid thereon;

FIG. 3 is an isolated side view of a support frame for the sensing system's data measurement and capture components in accordance with an embodiment of the present invention;

FIG. 4 is an isolated top view of the support frame taken along line 4-4 in FIG. 3; and

FIG. 5 is a side view of the sensing system's airborne assets to include its support frame and sensing/processing components mounted thereon in accordance with an embodiment of the present invention.

### DETAILED DESCRIPTION OF THE INVENTION

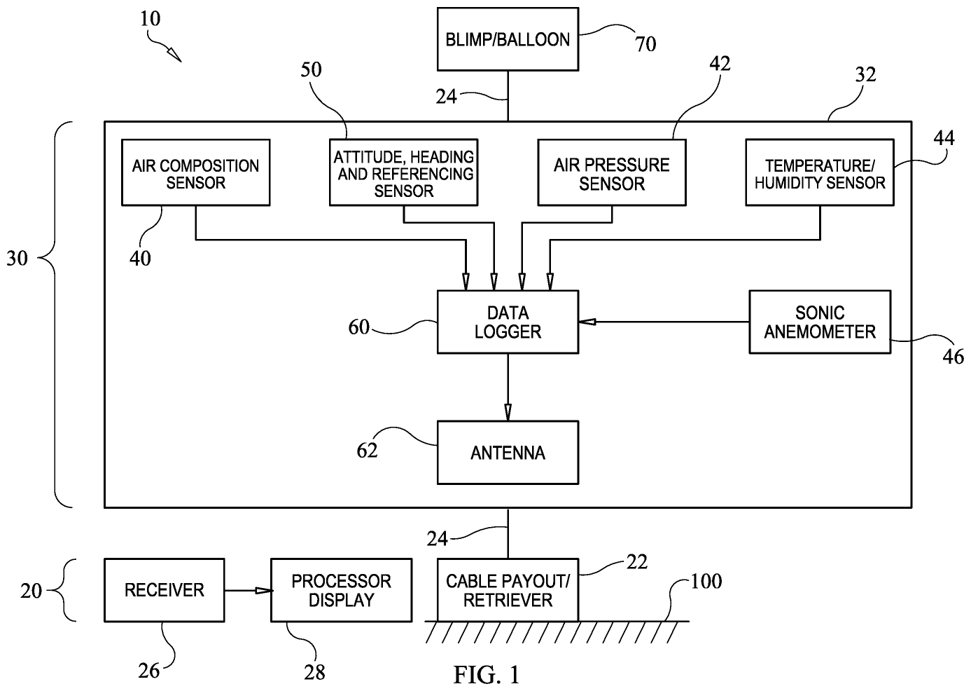

Referring now to the drawings and more particularly to FIG. 1, a motion-compensating sensing system for the collection (i.e., measurement and capture) of accurate atmospheric relevant parameters in accordance with the present invention is illustrated schematically and is referenced generally by numeral 10. Sensing system 10 includes ground-based assets referenced generally by numeral 20 and airborne assets referenced generally by numeral 30. Briefly, airborne assets 30 is a unique atmospheric data collection platform that includes mechanical, sensing, and processing features that allow system 10 to measure and capture a variety of atmospheric relevant parameters as airborne assets 30 transit through an atmospheric boundary layer while compensating for transit-motion effects on some of the measured data.

Ground-based assets 20 include mechanical and processing features that control transit motion of airborne assets 30, and provide the hardware and software needed for retrieving/receiving, processing, and displaying the atmospheric relevant parameters measured/captured by airborne assets 30. As will be explained further below, either ground assets 20 or airborne assets 30 incorporates a unique motion-compensation processing technique that will be applied to the raw wind data measured by airborne assets 30.

Ground-based assets 20 include a cable payout/retriever 22 housing a cable 24 that is long enough to allow airborne assets 30 to transit a boundary layer of interest. As would be understood in the art, cable payout/retriever 22 controls the payout and retrieval of cable 24. Cable 24 is coupled to an airborne asset support frame 32 in a way that contributes to the motion-compensation processing technique as will be explained further below. Ground-based assets 20 also include a receiver 26 for receiving atmospheric relevant data via wireless telemetry from airborne assets 30, and a processor/display 28 for processing/presenting the atmospheric relevant data via a variety of display options.

Airborne asset support frame 32 supports the unique and comprehensive sensing and processing features of the present invention. In terms of sensing, airborne assets 30 include an air composition sensor 40, an air pressure sensor 42, a temperature and humidity sensor 44, and a sonic anemometer 46. Each of the sensing assets can be realized by one or more devices without departing from the scope of the present invention. Additional sensors can be provided in accordance with an application's needs without departing from the scope of the present invention.

In addition to the above-noted sensors, airborne assets 30 include an altitude, heading, and referencing sensor (AHRS) 50 that can be a suite of sensors configured to provide continuous measurements of altitude, heading, yaw motion, pitch motion, roll motion, accelerations, and geographic location of airborne assets 30. As will be explained further below, AHRS 50 provides the data needed to compensate for motion-induced errors in the raw wind data. The data measured by each of the above sensors/devices is transmitted wirelessly from a data logger 60 to the ground-based receiver 26 via an antenna 62. The present invention applies motion compensation (as will be described further below) to the raw wind data measured by sonic anemometer 46 and prepares the data for archive and display. Since sonic anemometers are designed for operation at a fixed position, the motion compensation provided by the present invention introduces a new wind data paradigm for tethered instrumentation practice.

Air composition sensor 40 is any single or multi-sensor arrangement for measuring the constituent elements of the air in which it resides. Air pressure sensor 42 is a barometer. Temperature and humidity sensor 44 is a sensor or multi-sensor arrangement for measuring the temperature and relative humidity of the air in which it resides. Sonic anemometer 46 measures three-dimensional wind data using ultrasound. Briefly, sonic anemometer 46 is a flow-through multi-probe device that transmits ultrasonic energy between spaced-apart probes in each of three-dimensions in order to determine wind speed and direction as the air flows through the anemometer. The above-described sensors and sonic anemometer are well-known types of devices and are commercially available. A lighter-than-air blimp or balloon 70, tethered to support frame 32 (e.g., via tether 24), serves as the motive force to raise airborne assets 30 vertically through an atmospheric boundary layer during a measurement session.

As mentioned above, AHRS 50 continuously measures altitude, heading, yaw, pitch, roll, accelerations, and GPS location of airborne assets 30 during vertical transit thereof through an atmospheric region. By way of an illustrative example, AHRS 50 can be a commercially-available GNSS-aided inertial navigation system such as one of the Model 3DM-GX5 family of packaged sensor systems available from Parker Hannifin Corporation, Williston, Vt. Data from AHRS 50 will provide the required information (i.e., the yaw, pitch, roll, accelerations, and GPS data measurements that airborne assets 30 experience) to enable the determination of how much motion was captured in each sample of wind data measured by sonic anemometer 46. Briefly, the present invention applies vector calculus to factor out the three-dimensional motion from each of the “u” (east/west), “v” (north/south) and “w” (vertical) components of the wind data measured by sonic anemometer 46 in order to arrive at a more accurate calculated wind speed and wind direction values in accordance with the technique described further herein below.

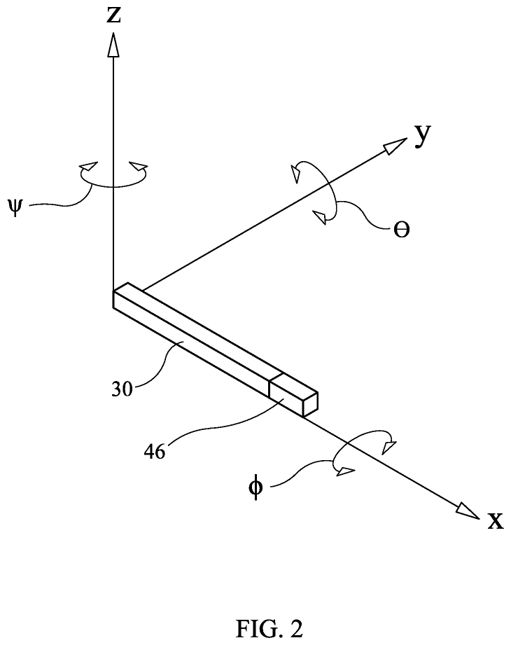

Referring additionally now to FIG. 2, a schematic view of airborne assets 30 to include sonic anemometer 46 is illustrated with an x,y,z reference frame overlaid thereon. Since sonic anemometers are designed to be fixed-position measurement tools, the present invention employs a motion compensation scheme that begins by assuming a fixed three-dimensional x,y,z reference frame where rotation about the x-axis indicates roll through an angle ϕ, rotation about the y-axis indicates pitch through an angle Θ, and rotation about the z-axis indicates yaw through and angle Ψ. Each such rotation can be expressed as a 3×3 matrix where Rₓ(ϕ) is the 3×3 matrix governing roll, R_{y}(Θ) is the 3×3 matrix governing pitch, and R_{z}(Ψ) is the 3×3 matrix governing yaw as follows:

$${R}_{x} ( ϕ ) = [ \begin{matrix}1 & 0 & 0 \\ 0 & cos Φ & - s in Φ \\ 0 & sin Φ & cos Φ\end{matrix} ]$$

$${R}_{y} ( Θ ) = [ \begin{matrix}cos Θ & 0 & sin Θ \\ 0 & 1 & 0 \\ - s in Θ & 0 & cos Θ\end{matrix} ]$$

$${R}_{z} ( Ψ ) = [ \begin{matrix}cos Ψ & - s in Ψ & 0 \\ sin Ψ & cos Ψ & 0 \\ 0 & 0 & 1\end{matrix} ]$$

At each measurement sample, the sonic anemometer measures raw wind data in the coordinate frame x, y, z having roll ϕ, pitch Θ, and yaw Ψ angles associated therewith. Each measured sample of wind data would then normally be transformed or mapped to a fixed horizontal reference frame. However, the sonic anemometer's reference frame is always moving relative to a local fixed horizontal reference plane. At any location on the Earth's surface, the local fixed horizontal plane is the horizontal plane extending in the magnetic east/west and magnetic north/south directions and normal to the local gravitational vector. Accordingly, the sampled wind data must be transformed or mapped into the local fixed horizontal reference plane with the corresponding coordinate frame thereof designated herein by (x′″y′″z′″).

In general, the present invention applies motion compensation to each measured sample of wind data using the (measured) roll, pitch and yaw angles of the sonic anemometer in order to orient or map/transform the samples of wind data to Magnetic North. Briefly, the roll and pitch angles are applied to the x,y,z components of the samples of wind data thereby translating the samples into corresponding fixed-horizontal-plane wind components. Next, the yaw angle is applied to the fixed-horizontal-plane wind components thereby generating motion-compensated wind components related to Magnetic North. The motion-compensated data is then averaged over a user defined number of samples. Well-known wind speed and wind direction calculations are then performed using the averaged data to provide accurate motion-compensated wind data. This will be explained from a computational perspective immediately below.

Translating the samples of wind data into corresponding fixed-horizontal-plane wind components using the roll and pitch angles is a straightforward computational process that would be well understood in the art. However, generating motion-compensated wind components related to Magnetic North of the fixed local horizontal plane in accordance with the present invention utilizes some unique design aspects of system 10. If it is assumed the sonic anemometer's fixed reference frame's x-axis is maintained in a generally horizontal orientation such that the fixed reference plane of the sonic anemometer is perpendicular to the local gravitational vector, it is sufficient to introduce an azimuthal angle correction with respect to Magnetic North derived from the yaw angle for each sample of wind data. As will be explained further below, the airborne assets 30 to include support frame 32 provides for the stability of the orientation. The azimuthal angle Ψ with respect to Magnetic North is sampled using AHRD 50 along with each wind measurement sample. Since the sonic anemometer is positioned (by virtue of support frame 32 being tethered to blimp/balloon 70) such that its z-axis of its reference frame is oriented perpendicular to the local gravitational vector, only the azimuthal angle Ψ with respect to Magnetic North is needed to transform/map the sampled wind data to the local tangent plane. That is, only the rotation angle Ψ with respect to Magnetic North is needed to transform the sampled wind data to the local fixed horizontal reference plane in the corresponding reference frame (x′″y′″z′″) as follows:

$$( \begin{matrix}{x}^{′′′} \\ {y}^{′′′} \\ {z}^{′′′}\end{matrix} ) = [ \begin{matrix}cos Ψ & - sin Ψ & 0 \\ sin Ψ & cos Ψ & 0 \\ 0 & 0 & 1\end{matrix} ] ( \begin{matrix}{x}^{′′} \\ {y}^{′′} \\ {z}^{′′}\end{matrix} )$$

where (x″,y″,z″) represent the fixed horizontal reference frame just prior to rotation to Magnetic North.

Using the above relationships, the present invention factors out the three-dimensional motion of the sonic anemometer from each of the “u” (east/west), “v” (north/south) and “w” (vertical) velocity components from the sonic anemometer's sampled wind data as follows:

$$( \begin{matrix}u \\ v \\ w\end{matrix} ) = [ \begin{matrix}cos α & - sin α & 0 \\ sin α & cos α & 0 \\ 0 & 0 & 1\end{matrix} ] ( \begin{matrix}{x}^{′′′} \\ {y}^{′′′} \\ {z}^{″′}\end{matrix} )$$

where α is the local magnetic variation angle and u, v and w are the local tangent plane coordinates relative to true north. The above matrix yields
u=x′″ cos α−y′″ sin α
v=x′″ sin α+y′″ cos α
w=−z′″.

Since factoring out dimensional motion in the present invention involves an averaging process, it is necessary to introduce the subscript “i” into the above relationships where “i” is the sample number (i.e., i=1, 2, 3, etc.) such that

$$( \begin{matrix}{u}_{i} \\ {v}_{i} \\ {w}_{i}\end{matrix} ) = ( \begin{matrix}u \\ v \\ w\end{matrix} )$$

In order to compute the mean wind speed and mean wind direction, it is necessary to select a sampling period “k” to generate an average. For example, the components are averaged in each sampling period “k”, consisting of m samples as follows:

$$\overline{{u}_{k}} = \frac{1}{m} {\sum }_{j = 1}^{m} {u}_{j}$$

$$\overline{{v}_{k}} = \frac{1}{m} {\sum }_{j = 1}^{m} {v}_{j}$$

$$\overline{{w}_{k}} = \frac{1}{m} {\sum }_{j = 1}^{m} {w}_{j}$$

Then, for averaging period “k”, the motion-compensated horizontal wind speed is given by

$${v}_{k} = \sqrt{{\overline{{u}_{k}}}^{2} + {\overline{{v}_{k}}}^{2}} ,$$

the motion-compensated horizontal wind direction is given by

$${θ}_{k} = {tan}^{- 1} ( \frac{\overline{- {v}_{k}}}{\overline{- {u}_{k}}} ) + 180 ° ,$$

and
the motion-compensated vertical wind speed is given by
w̅ₖ.

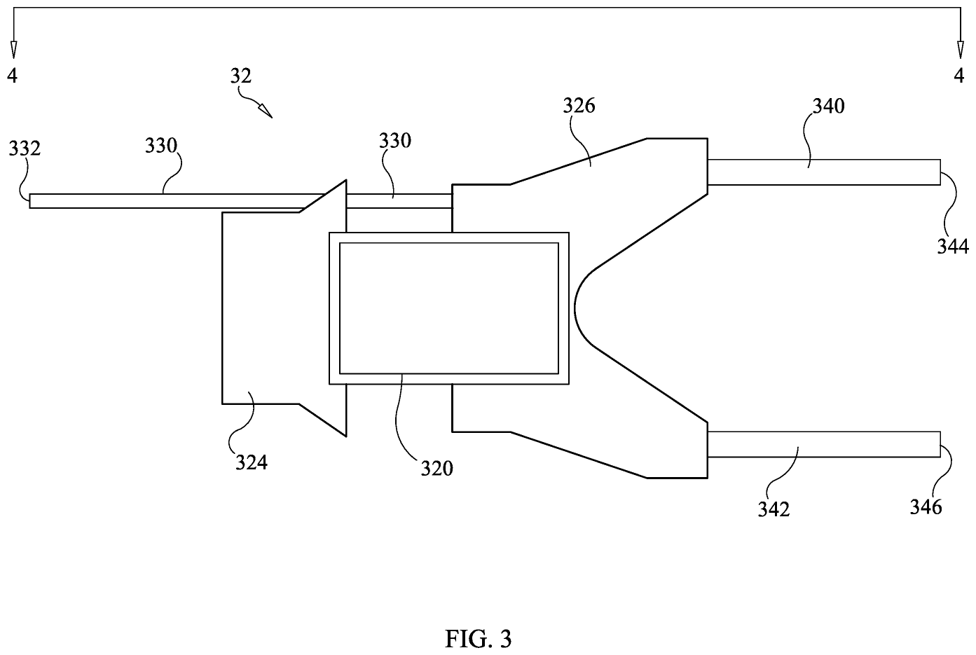

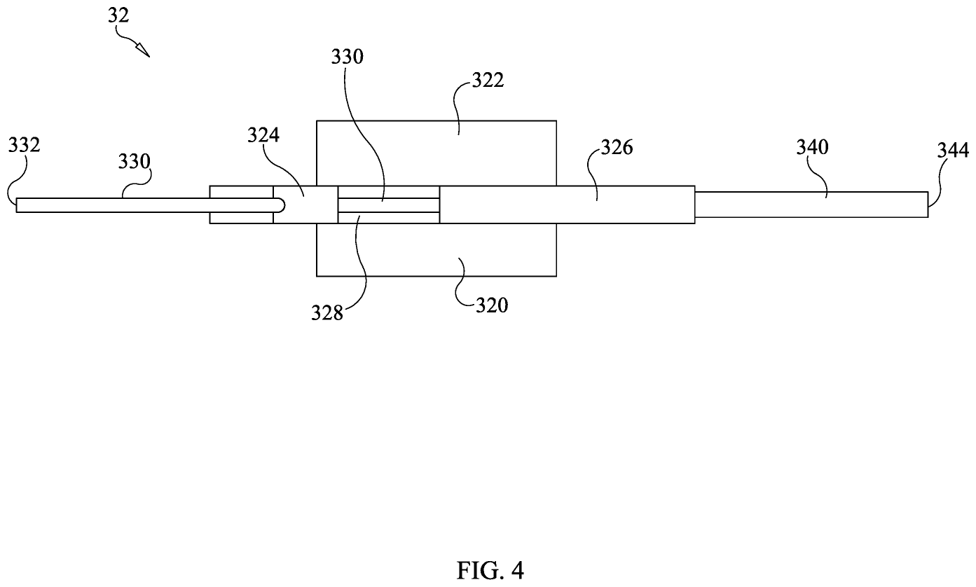

Referring now simultaneously to FIGS. 3-4, isolated side (FIG. 3) and top views (FIG. 4) are shown of an embodiment of support frame 32 that provides mechanical support for the sensing and processing components of airborne assets 30. Support frame 32 is generally a rigid and lightweight structure that can be one-piece or assembled from multiple pieces without departing from the scope of the present invention. Support frame 32 can be made from plastics, composites, metals, or combinations thereof. Support frame 32 provides for the structural placement and support of the system's sensing and processing components in support of the mission of sensing system 10. The mechanical aspects of support frame 32 contribute to an overall weight balance for airborne assets 30 that ensures proper horizontal orientation with respect to the wind direction and accurate atmospheric relevant data measurements as airborne assets 30 are moved through an atmospheric boundary layer.

Support frame 32 includes a central body having two identical open-box shells 320 and 322 where shell 322 is only visible in FIG. 4, an antenna and fin support base 324, and a sonic-probe support base 326. Each of shells 320 and 322 is an open box-like container that opens to the side of support frame 32, i.e., facing out of the paper in FIG. 3 for shell 320 and towards the top of the paper in FIG. 4 for shell 322. After being populated with instruments as will be described further below, each of shells 320/322 can be closed using a protective cover plate (not shown). Each of shells 320 and 322 has its closed back wall coupled to antenna/fin support base 324 and sonic-probe support base 326 such that an open-ended duct 328 passes between the arrangement of shells 320/322 and support bases 324/326 as shown in FIG. 4. A rigid rod 330 is supported by and is coupled to antenna/fin support base 324 and sonic-probe support base 326. In some embodiments of the present invention, rod 330 is adjacent to and is aligned with one end of open-ended duct 328 to define a rigid support for reasons that will be explained further below. Rod 330 extends to an outboard end thereof as indicated by reference numeral 332. Two rigid conduits 340 and 342 are supported in a spaced-apart relationship by, and are coupled to, sonic-probe support base 326. Each of conduits 340 and 342 extend to open outboard ends 344 and 346, respectively.

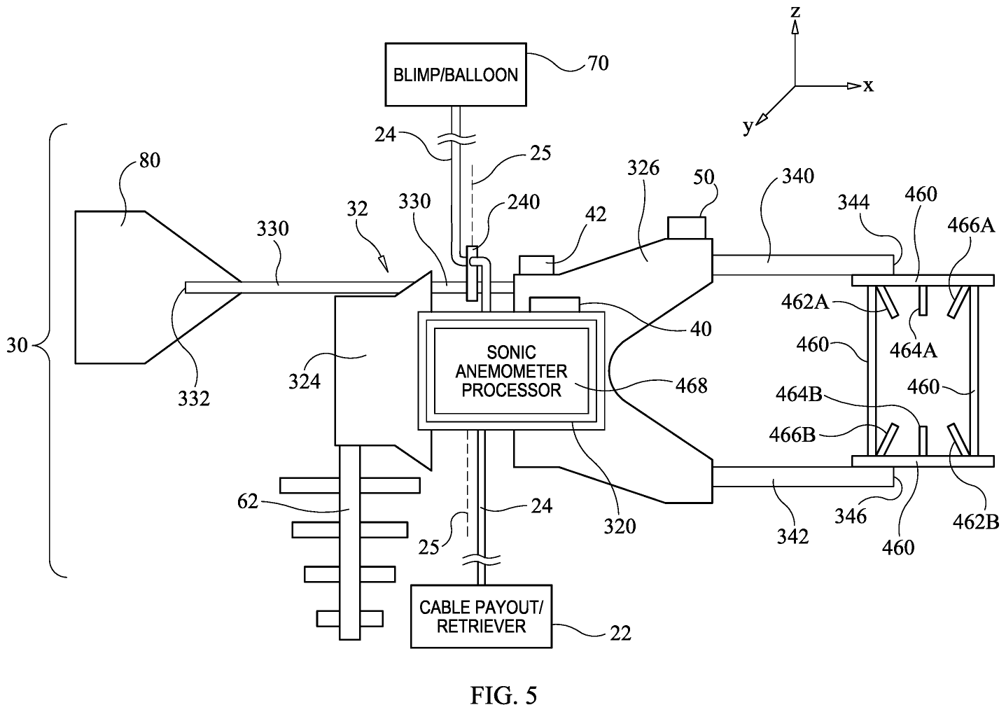

Referring additionally now to FIG. 5, a side view is shown of an embodiment of the airborne assets 30 utilizing the above-described and illustrated support frame 32. For clarity of illustration, electrical cables coupling the various sensing/processing components have been omitted from FIG. 5. It is to be understood that a variety of wire dressing techniques can be used without departing from the scope of the present invention. For example, the various electrical cables can be dressed within and through the above-described portions of support frame 32 whenever possible.

Mounted to the outboard end 332 of rigid rod 330 is a rigid fin 80 providing directional stability of the airborne assets. More specifically, fin 80 is sized/shaped to keep airborne assets 30 pointed into (i.e., aligned with) the wind at all times, while also contributing to the weight balance of airborne assets 30 relative to tether 24 that is needed to maintain airborne assets 30 in a substantially perpendicular relationship to the local gravitational vector. In this way, as airborne assets 30 transit through an atmospheric boundary layer, the airborne assets are maintained in a generally stable horizontal (x-axis) orientation. Accordingly, fin 80 is a structural and functional part of support frame 32. Antenna 62 is rigidly coupled to antenna/fin support base 324 in a position that provides for optimal wireless data transmission to the above-described ground-based receiver 26.

Mounted to the outboard ends 344/346 of conduits 340/342 is the probe arrangement of the above-described sonic anemometer 46. More specifically, a probe frame 460 supports three pairs of opposing ultrasonic probes where each probe pair 462A/462B, 464A/464B, and 466A/466B is used to ultrasonically measure wind data in one of three dimensions as air flows through frame 460 and between the probe pairs. Electrical cables (not shown) connect the probe pairs to a sonic anemometer processor 468 mounted in shell 320. Processor 468 controls the transmission/reception of ultrasonic energy to/from the probe pairs, and provides the collected data to onboard data logger 60 mounted, for example, in second shell 322.

The remaining atmospheric relevant sensors can be mounted to support frame 32 as follows:
air composition sensor 40 can be mounted on top of shell 320 housing processor 468;
temperature and humidity sensor 42 can be mounted between shells 320/322 on the forward section of sonic-probe support base 326;
air pressure sensor 44 can be mounted within shell 322 alongside of data logger 60 (not visible in FIG. 5); and
AHRS 50 can be mounted on top of sonic-probe support base 326 adjacent to rigid conduit 340.

Electric power for the sensors, processor, etc., can be provided by a battery (not shown) mounted in an appropriate location on support frame 32. Outputs from the atmospheric relevant sensors to include the sonic anemometer data from processor 468 are provided to the above-described onboard data logger 60. Although not illustrated in FIG. 5, the onboard data logger 60 can be mounted in the second shell 322 (FIG. 4). It is to be understood that the positioning of the various sensing/processing/communication elements of airborne assets 30, along with the mechanical attributes of support frame 32 the coupling of tether 24 thereto, can be realized in a variety of ways without departing from the scope of the present invention.

In some embodiments of the present invention, cable 24 extends from the ground-based cable payout/retriever 22 through airborne assets 30 via open-ended duct 328 (FIG. 4) between shells 320/322 before being connected to blimp/balloon 70. Cable 24 is also connected to airborne assets 30 using, for example, a clip 240 that is coupled to rod 330 where it extends over open-ended duct 328. The passage of cable 24 through open-ended duct 328 in combination with the provision of fin 80 allows airborne assets 30 to readily adapt to changing wind directions by permitting airborne assets 30 to rotate about the vertical axis referenced by dashed line 25.

The advantages of the present invention are numerous. The sensing system can measure and capture high-resolution atmosphere-related data as the sensor package travels within an atmospheric boundary layer. The system's support frame optimally positions the sensing components so that motion-compensation can be applied to a sonic anemometer's sampled wind data to provide in-situ three-dimensional wind data that greatly improves the accuracy and value of the measured atmosphere-related information.

Although the invention has been described relative to specific embodiments thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A system for collecting atmospheric data, comprising:
a frame;
sensors coupled to said frame for sensing atmospheric relevant parameters, said sensors including a sonic anemometer for measuring wind data samples in each of three dimensions, said sensors further including motion sensors for measuring angles of roll motion, pitch motion and yaw motion of said sonic anemometer at each of said wind data samples;
a tether having a first end and a second end, said first end adapted to be coupled to a cable payout/retriever, said second end adapted to be coupled to a lighter-than-air balloon, said tether coupled to said frame between said first end and said second end, wherein the payout/retriever and the balloon are adapted to control movement of said frame through a region of an atmosphere; and
a processor for receiving said wind data samples and said angles, said processor executing computer-readable instructions wherein said processor is configured by said computer-executable instructions for
mapping said wind data samples to a fixed local horizontal reference plane of said sonic anemometer that is normal to a local gravitational vector at the region of the atmosphere using said angles, wherein samples of compensated data are generated, and
averaging a plurality of said samples of compensated data, wherein averaged compensated data is generated and is indicative of wind speed and wind direction in the region of the atmosphere.

2. A system as in claim 1, wherein said frame includes a fin for controlling movement of said frame relative to said tether as said frame experiences said movement through the region of the atmosphere.

3. A system as in claim 1, wherein said frame includes a fin adapted to align said frame with a direction of wind in the region of the atmosphere as said frame experiences said movement through the region of the atmosphere.

4. A system as in claim 1, wherein said tether passes through said frame.

5. A system for collecting atmospheric data, comprising:
a frame having an open-ended duct passing there through, said frame including a rigid support adjacent to and aligned with one end of said open-ended duct;
sensors coupled to said frame for sensing atmospheric relevant parameters, said sensors including a sonic anemometer for measuring wind data samples in each of three dimensions, said sensors further including motion sensors for measuring angles of roll motion, pitch motion and yaw motion of said sonic anemometer at each of said wind data samples;
a tether having a first end and a second end, said first end adapted to be coupled to a cable payout/retriever, said second end adapted to be coupled to a lighter-than-air balloon, said tether coupled to said rigid support between said first end and said second end, said tether passing through said open-ended duct, wherein the payout/retriever and the balloon are adapted to control movement of said frame through a region of an atmosphere; and
a processor for receiving said wind data samples and said angles, said processor executing computer-readable instructions wherein said processor is configured by said computer-executable instructions for
mapping said wind data samples to a fixed local horizontal reference plane of said sonic anemometer that is normal to a local gravitational vector at the region of the atmosphere using said angles, wherein samples of compensated data are generated, and
averaging a plurality of said samples of compensated data, wherein averaged compensated data is generated and is indicative of wind speed and wind direction in the region of the atmosphere.

6. A system as in claim 5, wherein said frame includes a fin for controlling movement of said frame relative to said tether as said frame experiences said movement through the region of the atmosphere.

7. A system as in claim 5, wherein said frame includes a fin adapted to align said frame with a direction of wind in the region of the atmosphere as said frame experiences said movement through the region of the atmosphere.

8. A system as in claim 5, wherein said frame includes a fin at a first end thereof, wherein said sonic anemometer is coupled to said frame at a second end thereof, wherein said frame is adapted to be aligned with a direction of wind in the region of the atmosphere as said frame experiences said movement through the region of the atmosphere, and wherein the fixed local horizontal reference plane of said sonic anemometer is adapted to be perpendicular to the local gravitational vector as said frame experiences said movement through the region of the atmosphere.

9. A system for collecting atmospheric data, comprising:
an atmospheric data collection platform that includes a sonic anemometer for measuring wind data samples in each of three dimensions and motion sensors for measuring angles of roll motion, pitch motion and yaw motion of said sonic anemometer at each of said wind data samples;
a tether having a first end and a second end, said first end adapted to be coupled to a cable payout/retriever, said second end adapted to be coupled to a lighter-than-air balloon, said tether coupled to said platform between said first end and said second end, wherein the payout/retriever and the balloon are adapted to control movement of said platform through a region of an atmosphere;
said platform being weight balanced relative to said tether, wherein a fixed local horizontal reference plane of said sonic anemometer is maintained normal to a local gravitational vector at the region of the atmosphere as said platform experiences said movement through the region of the atmosphere; and
a processor for receiving said wind data samples and said angles, said processor executing computer-readable instructions wherein said processor is configured by said computer-executable instructions for
mapping said wind data samples to the fixed local horizontal reference plane of said sonic anemometer that is normal to the local gravitational vector at the region of the atmosphere using said angles, wherein samples of compensated data are generated, and
averaging a plurality of said samples of compensated data, wherein averaged compensated data is generated and is indicative of wind speed and wind direction in the region of the atmosphere.

10. A system as in claim 9, wherein said platform includes a fin for controlling movement of said platform relative to said tether as said platform experiences said movement through the region of the atmosphere.

11. A system as in claim 9, wherein said platform includes a fin adapted to align said platform with a direction of wind in the region of the atmosphere as said platform experiences said movement through the region of the atmosphere.

12. A system as in claim 9, wherein said tether passes through said platform.
